(19) United States
(12) Patent Application Publication
(10) Pub. No.: US 2018/0122021 A1
(43) Pub. Date: May 3, 2018

(54) CHEMICAL REFINERY PERFORMANCE OPTIMIZATION

(71) Applicant: UOP LLC, Des Plaines, IL (US)

(72) Inventors: Ian G. Horn, Streamwood, IL (US); Christophe Romatier, Wilmette, IL (US); Paul Kowalczyk, Hoffman Estates, IL (US); Zak Alzein, Burr Ridge, IL (US)

(21) Appl. No.: 15/858,767

(22) Filed: Dec. 29, 2017

Related U.S. Application Data
(63) Continuation-in-part of application No. 15/058,658, filed on Mar. 2, 2016.
Application No. 15/058,658 is a continuation-in-part of application No. PCT/US2016/064306, filed on Dec. 1, 2016.
(60) Provisional application No. 62/127,642, filed on Mar. 3, 2015.
(60) Provisional application No. 62/267,966, filed on Dec. 16, 2015.

(51) Int. Cl. G06Q 50/04; G06Q 10/06

(52) U.S. Cl. CPC G06Q 50/04; G06Q 10/06395; G06Q 10/06316

(57) ABSTRACT

Processes and apparatuses for toluene methylation in an aromatics complex for producing paraxylene. More specifically, the present disclosure relates to processes and apparatuses wherein a toluene methylation zone is integrated within an aromatics complex for producing paraxylene thus allowing no benzene byproduct to be produced. This may be accomplished by incorporating a toluene methylation process into the aromatics complex and recycling the benzene to the transalkylation unit.

### CROSS-REFERENCE TO RELATED APPLICATIONS

This application is a continuation in part of International Application No. PCT/US2016/064306, filed Dec. 1, 2016, which claims priority of U.S. Provisional Application Ser. No. 62/267,966, filed Dec. 16, 2015. This application is also a continuation in part of U.S. application Ser. No. 15/058,658, filed Mar. 2, 2016, which claims priority under 35 U.S.C. § 119(e) of U.S. Provisional Application Ser. No. 62/127,642, filed Mar. 3, 2015. Each of these applications is incorporated herein by reference in its entirety.

### FIELD

This present disclosure relates to processes and apparatuses for toluene methylation in an aromatics complex for producing paraxylene. More specifically, the present disclosure relates to processes and apparatuses for toluene methylation within an aromatics complex for producing paraxylene where no benzene byproduct is produced.

The present disclosure is also related to managing the operation of a plant, such as a petrochemical plant or a chemical refinery, and more particularly to improving the operational performance a plant.

### BACKGROUND

The xylene isomers are produced in large volumes from petroleum as feedstocks for a variety of important industrial chemicals. The most important of the xylene isomers is para-xylene, the principal feedstock for polyester, which continues to enjoy a high growth rate from large base demand. Ortho-xylene is used to produce phthalic anhydride, which supplies high-volume but relatively mature markets. Meta-xylene is used in lesser but growing volumes for such products as plasticizers, azo dyes and wood preservers. Ethylbenzene generally is present in xylene mixtures and is occasionally recovered for styrene production, but is usually considered a less-desirable component of C₈ aromatics.

Among the aromatic hydrocarbons, the overall importance of xylenes rivals that of benzene as a feedstock for industrial chemicals. Xylenes and benzene are produced from petroleum by reforming naphtha but not in sufficient volume to meet demand, thus conversion of other hydrocarbons is necessary to increase the yield of xylenes and benzene. Often toluene is de-alkylated to produce benzene or selectively disproportionated to yield benzene and C₈ aromatics from which the individual xylene isomers are recovered.

An aromatics complex flow scheme has been disclosed by Meyers in the HANDBOOK OF PETROLEUM REFINING PROCESSES, 2d. Edition in 1997 by McGraw-Hill, and is incorporated herein by reference.

Traditional aromatics complexes send toluene to a transalkylation zone to generate desirable xylene isomers via transalkylation of the toluene with A₉₊ components. A₉₊ components are present in both the reformate bottoms and the transalkylation effluent.

Paraxylene is most often produced from a feedstock that has a methyl to phenyl ratio of less than 2. As a result, the paraxylene production is limited by the available methyl groups in the feed. In addition, paraxylene production also typically produces benzene as a byproduct. Since paraxylene is more valuable than benzene and the other byproducts produced in an aromatics complex, there is a desire to maximize the paraxylene production from a given amount of feed. There are also cases where a paraxylene producer would prefer to avoid the production of benzene as a byproduct or paraxylene production. But there are also cases where a paraxylene producer would prefer to limit the production of benzene as a byproduct or paraxylene production by making adjustments.

Companies operating refineries and petrochemical complexes typically face tough challenges in today's environment. These challenges may include increasingly complex technologies or a reduction in workforce experience levels.

Operating companies continually seek to improve performance of existing equipment. Catalyst, adsorbent, equipment, and control system suppliers develop more complex systems that may increase performance. Maintenance and operation of these advanced systems generally requires advanced skill levels that may be difficult to develop, maintain, and transfer, given the time pressures and limited resources of today's technical personnel. This means that these increasingly complex systems are not always operated to their highest potential. In addition, as existing assets are operated close to and beyond their design limits, reliability concerns and operational risks may increase.

Plant operators typically respond to above challenges with, for example, availability risk reduction, working the value chain, and continuous optimization. Availability risk reduction generally places an emphasis on achieving adequate plant operations as opposed to maximizing performance. Working the value chain typically places an emphasis on improving the match of feed and product mix with equipment capabilities and desired production outputs. Continuous optimization often employs tools, systems, and models to continuously monitor and bridge gaps in plant performance.

There are two levels of gaps (or performance deficits) that refinery operators typically experience:

1) Events or “Lost Opportunities” Gap

Most refinery operators do a good job of tracking the impact of unplanned events in their refineries: unplanned shutdowns, equipment availability problems, and the like. The effects associated with these gaps is generally large, but the duration is normally short. Well-operated refineries may keep these events to a minimum through effective process and mechanical reliability programs.

2) Backcasting Gap

Some refineries focus on a backcasting (historical) gap. This is typically done on a monthly basis. The operator compares the monthly refinery production plan against the actual achieved operations, and conducts an analysis to understand and resolve the cause(s) for any gap(s). Refinery operators may often uncover substantial improvement if they resolve the root causes for deviation from refinery production process plans. But when root causes are embedded in poor process performance, they are often difficult to identify. This historical analysis also may be less effective in that it leaves issues unidentified and un-resolved until the end of the month.

Therefore, there is a need for an improved system for operators to respond to these challenges by using a strategy of optimization that employs tools, systems, and models to monitor and bridge gaps in plant performance.

### SUMMARY

The present disclosure relates to processes and apparatuses for toluene methylation in an aromatics complex for producing paraxylene. More specifically, the present disclosure relates to processes and apparatuses for toluene methylation within an aromatics complex for producing paraxylene where no benzene byproduct is produced. Integrating a toluene methylation process within an aromatics complex has several benefits. First, the integrated process may increase the amount of paraxylene that can be produced form a given amount of reformate. The integrated process may also reduce the amount of reformate required to produce a fixed amount of paraxylene. Second, the integrated process may avoid the production of benzene as a byproduct from the aromatics complex. These two benefits may be accomplished by incorporating a toluene methylation process into the aromatics complex and recycling the benzene to the transalkylation unit the aromatics complex.

A general object of the disclosure is to improve operational efficiency of petrochemical plants and refineries. A more specific object of this disclosure is to overcome one or more of the problems described above. A general object of this disclosure may be attained, at least in part, through a method for improving operation of a plant. The method may include obtaining plant operation information from the plant.

A method for improving operation of a plant may include obtaining plant operation information from the plant and generating a plant process model using the plant operation information. The method may include receiving plant operation information over the internet and automatically generating a plant process model using the plant operation information.

Configured process models may be used to monitor, predict, and/or optimize performance of individual process units, operating blocks, and/or complete processing systems. Routine and/or frequent analysis of predicted versus actual performance may allow early identification of operational discrepancies that may be acted upon to optimize impact.

Some embodiments may use a web-based computer system to execute work processes. A web-based computer system may improve plant performance due to an increased ability by operations to identify and capture opportunities, a sustained ability to bridge performance gaps, an increased ability to leverage personnel expertise, and/or improved enterprise management.

A data collection system at a plant may capture data, which may be automatically or manually sent to a remote location, where the data may be reviewed to, for example, eliminate errors and biases, and/or used to calculate and report performance results. The performance of the plant and/or individual process units of the plant may be compared to the performance predicted by one or more process models to identify any operating differences or gaps.

A report (e.g., an hourly, daily, weekly, monthly report) showing actual performance compared to predicted performance may be generated and delivered to a device accessible by a plant operator and/or a plant or third party process engineer. The report may be delivered via a network (e.g., the internet). The identified performance gaps may allow identification and/or resolution of the cause of the gaps. Process models and/or plant operation information may be used to run optimization routines that may converge on an optimal plant operation for given values (e.g., feed usage amounts, utility usage amounts, product output amounts, plant efficiency).

In some embodiments, the system may provide regular advice that may include recommendations to set or adjust setpoints, which may result in the plant running continuously at or closer to optimal conditions. Recommendations may include alternatives for improving or modifying the operations of the plant. In some embodiments, the system may regularly maintain and/or tune the process models to more closely represent the true potential performance of the plant. Some embodiments may include optimization routines configured per specific criteria, which may be used to identify optimum operating points, evaluate alternative operations, and/or evaluate feed.

In some embodiments, process development history, modeling and stream characterization, and/or plant automation experience may be used to improve data security, as well as efficient aggregation, management, and movement of large amounts of data.

In some embodiments, configured process models may be used to monitor, predict, and/or optimize performance of individual process units, operating blocks, or complete processing systems. Routine and/or frequent analysis of predicted versus actual performance may allow early identification of operational discrepancies that may be acted upon to optimize impact.

In one or more embodiments, a system may be provided for improving operation of a plant. A server may be coupled to the system for communicating with the plant via a communication network. A computer system may include a web-based platform for receiving and/or sending plant data related to the operation of the plant over the network. A display device may interactively display the plant data. An optimization unit may be configured for optimizing at least a portion of a refining or petrochemical process of the plant by acquiring the plant data from the plant on a recurring basis, analyzing the plant data for completeness, and/or correcting the plant data for an error. The optimization unit may correct the plant data for a measurement issue and/or an overall mass balance closure, and/or generate a set of reconciled plant data based on the corrected plant data.

In one or more embodiments, a system may be provided for improving operation of a plant. A server may be coupled to the system for communicating with the plant via a communication network. A computer system may include a web-based platform for receiving and/or sending plant data related to the operation of the plant over the network. A display device may interactively display the plant data. The display device may be configured for graphically or textually receiving an input signal from the system using an interface via a dedicated communication infrastructure. A visualization unit may be configured for creating an interactive display for a user, and/or displaying the plant data using a visual indicator on the display device based on a hue and color technique, which may discriminate a quality of the displayed plant data.

In one or more embodiments, a method may be provided for improving operation of a plant. The method may include providing a server coupled to a system for communicating with the plant via a communication network; providing a computer system having a web-based platform for receiving and sending plant data related to the operation of the plant over the network; providing a display device for interactively displaying the plant data, the display device being configured for graphically or textually receiving an input signal from the system using an interface via a dedicated communication infrastructure; creating an interactive display for a user, and/or displaying the plant data using a visual indicator on the display device based on a hue and color technique, which may discriminate a quality of the displayed plant data; and/or generating a plant process model using the plant data for predicting plant performance expected based on the plant data, the plant process model being generated by an iterative process that models based on at least one plant constraint being monitored for the operation of the plant.

The foregoing and other aspects and features of the present disclosure will become apparent to those of reasonable skill in the art from the following detailed description, as considered in conjunction with the accompanying drawings.

### Definitions

As used herein, the term “stream”, “feed”, “product”, “part” or “portion” can include various hydrocarbon molecules, such as straight-chain, branched, or cyclic alkanes, alkenes, alkadienes, and alkynes, and optionally other substances, such as gases, e.g., hydrogen, or impurities, such as heavy metals, and sulfur and nitrogen compounds. Each of the above may also include aromatic and non-aromatic hydrocarbons.

Hydrocarbon molecules may be abbreviated C₁, C₂, C₃, Cn where “n” represents the number of carbon atoms in the one or more hydrocarbon molecules or the abbreviation may be used as an adjective for, e.g., non-aromatics or compounds. Similarly, aromatic compounds may be abbreviated A₆, A₇, A₈, An where “n” represents the number of carbon atoms in the one or more aromatic molecules. Furthermore, a superscript “+” or “−” may be used with an abbreviated one or more hydrocarbons notation, e.g., C₃₊ or C₃₋, which is inclusive of the abbreviated one or more hydrocarbons. As an example, the abbreviation “C₃₊” means one or more hydrocarbon molecules of three or more carbon atoms.

As used herein, the term “zone” or “unit” can refer to an area including one or more equipment items and/or one or more sub-zones. Equipment items can include, but are not limited to, one or more reactors or reactor vessels, separation vessels, distillation towers, heaters, exchangers, pipes, pumps, compressors, and controllers. Additionally, an equipment item, such as a reactor, dryer, or vessel, can further include one or more zones or sub-zones.

As used herein, the term “rich” can mean an amount of at least generally 50%, and preferably 70%, by mole, of a compound or class of compounds in a stream.

As depicted, process flow lines in the FIGURES can be referred to interchangeably as, e.g., lines, pipes, feeds, gases, products, discharges, parts, portions, or streams.

The term “feeding” means that the feed passes from a conduit or vessel directly to an object without passing through an intermediate vessel.

The term “passing” includes “feeding” and means that the material passes from a conduit or vessel to an object.

As used herein, the term “kilopascal” may be abbreviated “kPa” and the term “megapascal” may be abbreviated “MPa”, and all pressures disclosed herein are absolute.

As used herein, references to a “routine” refer to a sequence of computer programs or instructions for performing a particular task. References to a “plant” refer to any of various types of chemical and petrochemical manufacturing or refining facilities. References to a plant “operator” refer to and/or include, without limitation, plant planners, managers, engineers, technicians, and others interested in, overseeing, and/or running the daily operations at a plant.

### BRIEF DESCRIPTION OF THE DRAWINGS

FIG. 1 depicts an illustrative embodiment of an aromatics complex having an integrated toluene methylation zone in accordance with one or more embodiments of the present disclosure;

FIG. 2 depicts an illustrative embodiment of an aromatics complex having an integrated toluene methylation zone in accordance with one or more embodiments of the present disclosure;

FIG. 3 depicts an illustrative embodiment of an aromatics complex having an integrated toluene methylation zone in accordance with one or more embodiments of the present disclosure;

FIG. 4 depicts an illustrative embodiment of an aromatics complex having an integrated toluene methylation zone in accordance with one or more embodiments of the present disclosure;

FIG. 5 depicts an illustrative use of the present system in a cloud computing infrastructure in accordance with one or more embodiments of the present disclosure;

FIG. 6 depicts an illustrative functional block diagram of a system that includes functional units in accordance with one or more embodiments of the present disclosure;

FIGS. 7A-7E depict illustrative dashboards for displaying hierarchical data that may be used with a system in accordance with one or more embodiments of the present disclosure; and

FIG. 8 depicts a flowchart of an illustrative method in accordance with one or more embodiments of the present disclosure.

### DETAILED DESCRIPTION

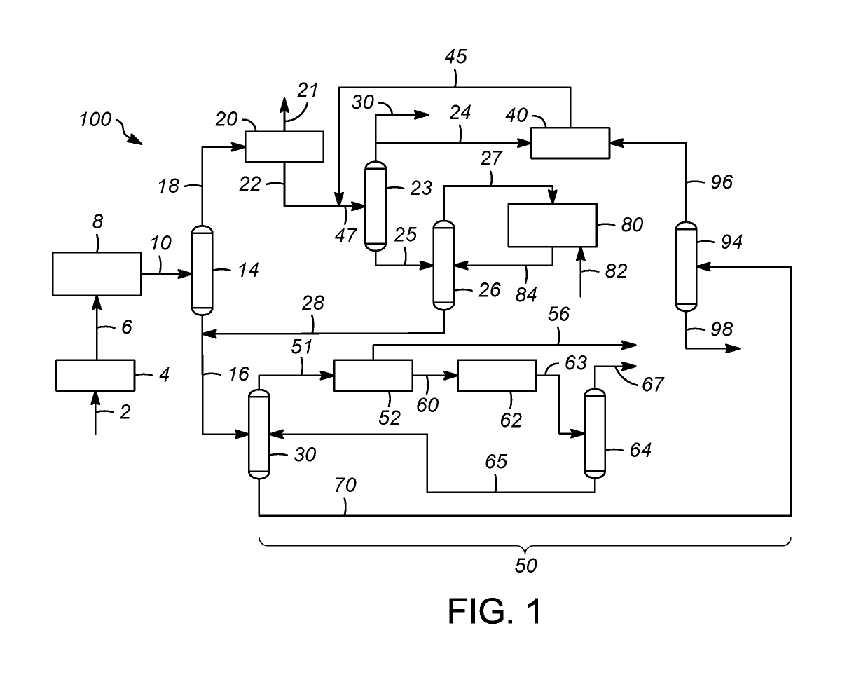

The feedstream to the present process generally comprises alkylaromatic hydrocarbons of the general formula C₆H₍₆₋ₙ₎Rₙ, where n is an integer from 0 to 5 and each R may be CH₃, C₂H₅, C₃H₇, or C₄H₉, in any combination. The aromatics-rich feed stream to the process of the present disclosure may be derived from a variety of sources, including without limitation catalytic reforming, steam pyrolysis of naphtha, distillates or other hydrocarbons to yield light olefins and heavier aromatics-rich byproducts (including gasoline-range material often referred to as “pygas”), and catalytic or thermal cracking of distillates and heavy oils to yield products in the gasoline range. Products from pyrolysis or other cracking operations may be hydrotreated according to processes well known in the industry before being charged to the complex in order to remove sulfur, olefins and other compounds that would affect product quality and/or damage catalysts or adsorbents employed therein. Light cycle oil from catalytic cracking also may be beneficially hydrotreated and/or hydrocracked according to known technology to yield products in the gasoline range; the hydrotreating preferably also includes catalytic reforming to yield the aromatics-rich feed stream. FIG. 1 is a simplified flow diagram of an exemplary aromatics-processing complex of the known art directed to the production of at least one xylene isomer. The complex may process an aromatics-rich feed that has been derived, for example, from catalytic reforming in a reforming zone 6. The reforming zone generally includes a reforming unit 4 that receives a feed via conduit 2. The reforming unit typically comprises a reforming catalyst. Usually such a stream will also be treated to remove olefinic compounds and light ends, e.g., butanes and lighter hydrocarbons and preferably pentanes; such removal, however, is not essential to the practice of the broad aspects of this disclosure and is not shown. The aromatics-containing feed stream contains benzene, toluene and C₈ aromatics and typically contains higher aromatics and aliphatic hydrocarbons including naphthenes.

Turning now to FIG. 1, an aromatics complex and process in accordance with one aspect wherein the aromatics complex includes an integrated toluene methylation zone will be illustrated and described. FIG. 1 is a simplified flow diagram of an exemplary aromatics-processing complex integrated with a toluene methylation unit directed to the production of at least one xylene isomer. The complex may process an aromatics-rich feed that has been derived, for example, from catalytic reforming in a reforming zone. The reforming zone generally includes a reforming unit that receives a feed. The reforming unit will typically comprise a reforming catalyst. Usually such a stream will also be treated to remove olefinic compounds and light ends, e.g., butanes and lighter hydrocarbons and preferably pentanes; such removal, however, is not essential to the practice of the broad aspects of this disclosure and is not shown. The aromatics-containing feed stream contains benzene, toluene and C₈ aromatics and typically contains higher aromatics and aliphatic hydrocarbons including naphthenes.

An embodiment of a process and apparatus for producing paraxylene in an aromatics complex is addressed with reference to a process and apparatus 100 illustrating an aromatics complex having an integrated toluene methylation scheme according to an embodiment as shown in FIG. 1. The process and apparatus 100 includes a hydrotreating zone 4, a naphtha splitter 14, a reforming zone 8, a reformate splitter 14, an aromatics extraction unit 20, a benzene column 23, a toluene column 26, a transalkylation zone 40, a toluene methylation unit 80, a xylene fractionation column 30, a heavy aromatics column 94, a para-xylene column 52, an isomerization column 62, and an isomerization deheptanizer column 64.

In accordance with an exemplary embodiment as shown in FIG. 1, a hydrocarbon feedstream in line 2 may be passed to the hydrotreating zone 4. In accordance with the instant embodiment as discussed, the hydrocarbon feedstream in line 2 is a naphtha stream and hence interchangeably referred to as naphtha stream in line 2. The naphtha stream in line 2 may be provided to the hydrotreating zone 4 to produce a hydrotreated naphtha stream in line 6. As used herein, the term “naphtha” means the hydrocarbon material boiling in the range between 10° C. and 200° C. atmospheric equivalent boiling point (AEBP) as determined by any standard gas chromatographic simulated distillation method such as ASTM D2887, all of which are used by the petroleum industry. The hydrocarbon material may be more contaminated and contain a greater amount of aromatic compounds than is typically found in refinery products. The typical petroleum derived naphtha contains a wide variety of different hydrocarbon types including normal paraffins, branched paraffins, olefins, naphthenes, benzene, and alkyl aromatics. Although the present embodiment is exemplified by a naphtha feedstream, the process is not limited to a naphtha feedstream, and can include any feedstream with a composition that overlaps with a naphtha feedstream.

Referring to FIG. 1, the hydrotreating zone 4 may include one or more hydrotreating reactors for removing sulfur and nitrogen from the naphtha stream in line 2. A number of reactions take place in the hydrotreating zone 4 including hydrogenation of olefins and hydrodesulfurization of mercaptans and other organic sulfur compounds; both of which (olefins, and sulfur compounds) are present in the naphtha fractions. Examples of sulfur compounds that may be present include dimethyl sulfide, thiophenes, benzothiophenes, and the like. Further, reactions in the hydrotreating zone 4 include removal of heteroatoms, such as nitrogen and metals. Conventional hydrotreating reaction conditions are employed in the hydrotreating zone 4, which are known to one of ordinary skill in the art.

The hydrotreated naphtha stream in line 6 withdrawn from the hydrotreating zone 4 may be passed to the catalytic reforming unit in the reforming zone 8 to provide a reformate stream in line 10. In an aspect, the hydrotreated naphtha stream in line 6 may be passed to the catalytic reforming unit 8 to provide the reformate stream in line 10. The reforming conditions includes a temperature of from 300° C. to 500° C., and a pressure from 0 kPa(g) to 3500 kPa(g). Reforming catalysts generally comprise a metal on a support. This catalyst is conventionally a dual-function catalyst that includes a metal hydrogenation-dehydrogenation catalyst on a refractory support. The support can include a porous material, such as an inorganic oxide or a molecular sieve, and a binder with a weight ratio from 1:99 to 99:1. In accordance with various embodiments, the reforming catalyst comprises a noble metal comprising one or more of platinum, palladium, rhodium, ruthenium, osmium, and iridium. The reforming catalyst may be supported on refractory inorganic oxide support comprising one or more of alumina, a chlorided alumina a magnesia, a titania, a zirconia, a chromia, a zinc oxide, a thoria, a boria, a silica-alumina, a silica-magnesia, a chromia-alumina, an alumina-boria, a silica-zirconia and a zeolite.

The reformate feed stream is passed via conduit 10 to reformate splitter 14 and distilled to separate a stream comprising C₈ and heavier aromatics, withdrawn as a bottoms stream via a bottoms outlet in conduit 16, from toluene and lighter hydrocarbons recovered overhead via conduit 18. The toluene and lighter hydrocarbons are sent to extractive distillation process unit 20, which separates a largely aliphatic raffinate in conduit 21 from a benzene-toluene aromatics stream in conduit 22. The aromatics stream in conduit 22 is separated, along with stripped transalkylation product in conduit 45, which enters the benzene column 23 into a benzene stream in conduit 24 and a toluene-and-heavier aromatics stream in conduit 25, which is sent to a toluene column 26. The benzene stream in conduit 30 is a product stream. The benzene stream in conduit 24 is passed from the benzene column 23 to the transalkylation unit 40. In one embodiment, the transalkylation conditions may include a temperature of 320° C. to 440° C. The transalkylation zone may contain a first catalyst. In one embodiment, the first catalyst comprises at least one zeolitic component suitable for transalkylation, at least one zeolitic component suitable for dealkylation and at least one metal component suitable for hydrogenation. Toluene is recovered overhead from the toluene column 26 in conduit 27 and may be sent partially or totally to a toluene methylation unit 80 along with a methanol stream in conduit 82 as shown and discussed hereinafter.

The methanol stream in conduit 82 and the toluene in conduit 27 is passed to the toluene methylation unit 80 and produces a hydrocarbon stream in conduit 84. The hydrocarbon stream in conduit 84 is passed back to the toluene column 26. In one embodiment, the toluene methylation product stream has a paraxylene to total xylene ratio of at least 0.2, or preferably at least 0.5, or more preferably 0.8 to 0.95.

The toluene column 26 produces a product stream in conduit 28 contains para-xylene, meta-xylene, ortho-xylene and ethylbenzene and passes via conduit 16 to para-xylene separation process 50. The separation process operates, preferably via adsorption employing a desorbent, to provide a mixture of para-xylene and desorbent via conduit 51 to extract column 52, which separates para-xylene from returned desorbent; the para-xylene may be purified in finishing column, yielding a para-xylene product via conduit 56.

The raffinate, comprising a non-equilibrium mixture of xylene isomers and ethylbenzene, is sent via conduit 60 to isomerization reactor 62. The raffinate is isomerized in reactor 62, which contains an isomerization catalyst to provide a product approaching equilibrium concentrations of C₈₋ aromatic isomers. In one embodiment, the isomerization conditions include a temperature of 240° C. to 440° C. Further, the isomerization zone includes a second catalyst. In one embodiment, the second catalyst comprises at least one zeolitic component suitable for xylene isomerization, at least one zeolitic component suitable for ethylbenzene conversion, and at least one metal component suitable for hydrogenation. In one embodiment, the isomerization process is carried out in the vapor phase. In yet another embodiment, the isomerization process is carried out in the liquid phase. In one embodiment, the isomerization process converts ethylbenzene by dealkylation to produce benzene. In another embodiment, the isomerization process converts ethylbenzene by isomerization to produce xylenes.

The product is passed via conduit 63 to deheptanizer 64, which removes C₇ and lighter hydrocarbons with bottoms passing via conduit 65 to xylene column 30 to separate C₉ and heavier materials from the isomerized C₈₋ aromatics. Overhead liquid from deheptanizer 64 is sent to a stripper, which removes light materials overhead in conduit 67 from C₆ and C₇ materials, which are sent to the extractive distillation unit for recovery of benzene and toluene values.

The xylene column bottoms stream in line 70 may be passed to the heavy aromatics column 194 to separate heavy aromatics comprising C₁₁₊ alkylaromatic hydrocarbons from C₉ and C₁₀ alkylaromatics recovered as the heavy aromatics column overhead stream in line 96. The C₁₁₊ alkylaromatic hydrocarbons may be withdrawn from the heavy aromatics column 94 as a bottoms stream in line 98. The heavy aromatics column overhead stream in line 96 rich in C₉ and C₁₀ alkylaromatics may be blended with the benzene-enriched stream in line 24 to provide the transalkylation feed stream in line 24, which may be subsequently provide to the transalkylation zone 40 for production of additional xylenes and benzene as previously described.

There are many possible variations of this scheme, as the skilled routineer will recognize. For example, the entire C₆-C₈ reformate or only the benzene-containing portion may be subjected to extraction. Para-xylene may be recovered from a C₈₋ aromatic mixture by crystallization rather than adsorption. The separation zone may also contain a simulated moving bed adsorption unit. In one example, the simulated moving bed adsorption unit uses a desorbent with a lower boiling point than xylenes, such as toluene or benzene. In yet another embodiment, the simulated moving bed adsorption unit uses a desorbent with a higher boiling point than xylenes, such as paradiethylbenzene, paradiisopropylbenzene, tetralin, or paraethyltoluene. Meta-xylene as well as para-xylene may be recovered from a C₈₋ aromatic mixture by adsorption, and ortho-xylene may be recovered by fractionation. Alternatively, the C₉₋ and heavier stream or the heavy-aromatics stream is processed using solvent extraction or solvent distillation with a polar solvent or stripping with steam or other media to separate highly condensed aromatics as a residual stream from C₉₊ recycle to transalkylation. In some cases, the entire heavy-aromatic stream may be processed directly in the transalkylation unit. The present disclosure is useful in these and other variants of an aromatics-processing scheme, aspects of which are described in U.S. Pat. No. 6,740,788, which is incorporated herein by reference.

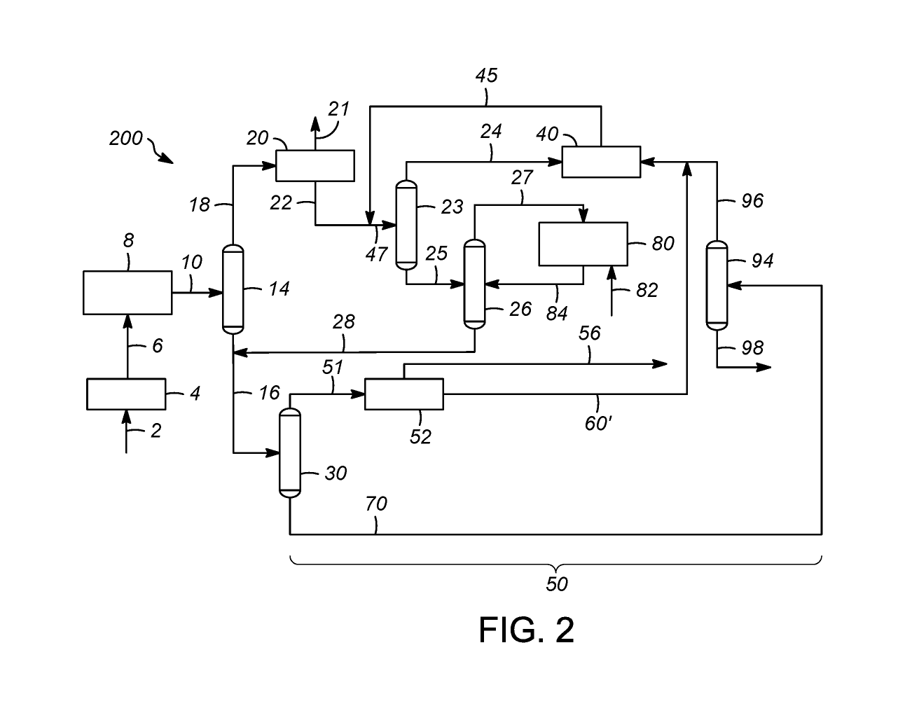

Turning now to FIG. 2, another embodiment of the aromatics complex is addressed with reference to a process and apparatus 200 providing an alternative integrated toluene methylation scheme. Many of the elements in FIG. 2 have the same configuration as in FIG. 1 and bear the same respective reference number and have similar operating conditions. Elements in FIG. 2 that correspond to elements in FIG. 1 but have a different configuration bear the same reference numeral as in FIG. 1 but are marked with a prime symbol (′). Further, the temperature, pressure and composition of various streams are similar to the corresponding streams in FIG. 1, unless specified otherwise. The apparatus and process in FIG. 2 are the same as in FIG. 1 with the exception of the noted following differences. In accordance with the exemplary embodiment as shown in the FIG. 2, the paraxylene raffinate comprising a non-equilibrium mixture of xylene isomers and ethylbenzene n line 60′ exits the paraxylene column 52 and is directed to the heavy aromatics column 94 overhead in conduit 96 to be directed into the transalkylation unit 40. As illustrated in FIG. 2, there is no isomerization zone or deheptanizer 64. The benefits of this configuration include the elimination of some equipment (reduced capital expense) and reduction in operating expense (energy/utility consumption). The process may increase the amount of paraxylene that can be produced form a given amount of reformate. The process may also reduce the amount of reformate required to produce a fixed amount of paraxylene. Further, the process may avoid the production of benzene as a byproduct from the aromatics complex.

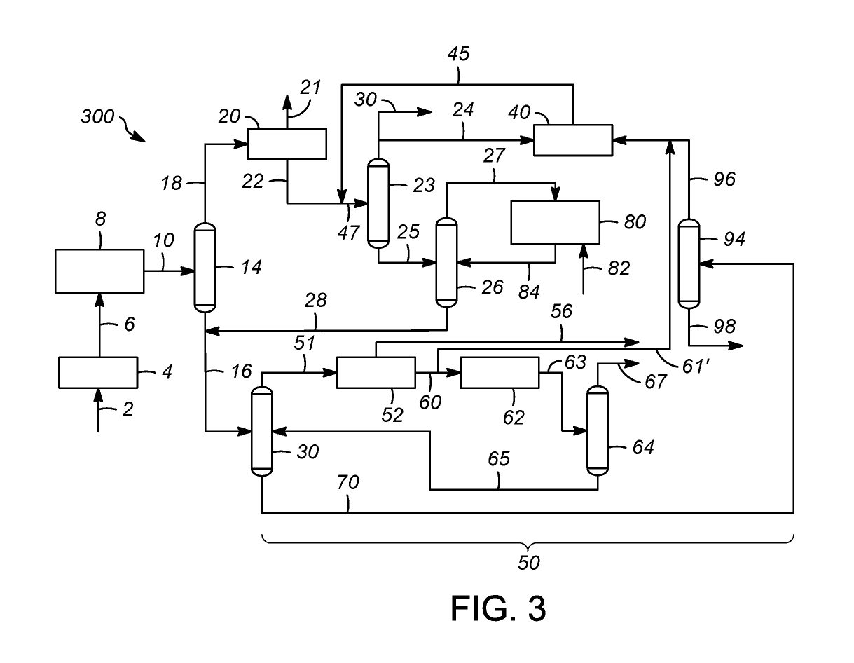

Turning now to FIG. 3, another embodiment of the aromatics complex is addressed with reference to a process and apparatus 300 providing an alternative integrated toluene methylation scheme. Many of the elements in FIG. 3 have the same configuration as in FIG. 1 and bear the same respective reference number and have similar operating conditions. Elements in FIG. 3 that correspond to elements in FIG. 1 but have a different configuration bear the same reference numeral as in FIG. 1 but are marked with a prime symbol (′). Further, the temperature, pressure and composition of various streams are similar to the corresponding streams in FIG. 1, unless specified otherwise. The apparatus and process in FIG. 3 are the same as in FIG. 1 with the exception of the noted following differences. In accordance with the exemplary embodiment as shown in the FIG. 3, a portion of the paraxylene raffinate comprising a non-equilibrium mixture of xylene isomers and ethylbenzene in line 61′ exits the paraxylene column 52 and is directed to the heavy aromatics column 94 overhead in conduit 96 to be directed into the transalkylation unit 40. As illustrated in FIG. 2, the remaining portion of conduit 60 remains connected to the isomeraztion unit 62, which is then connected to the deheptanizer 64. The benefits of this configuration include the fact that the process may increase the amount of paraxylene that can be produced form a given amount of reformate. Further, the process may also reduce the amount of reformate required to produce a fixed amount of paraxylene. Finally, the process may avoid the production of benzene as a byproduct from the aromatics complex.

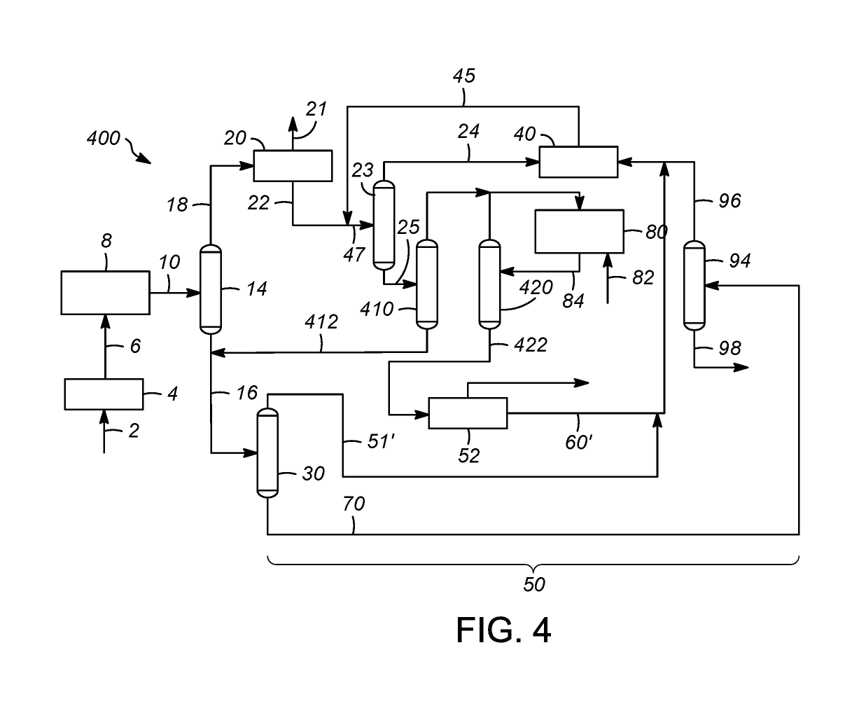

Turning now to FIG. 4, another embodiment of the aromatics complex is addressed with reference to a process and apparatus 400 providing an alternative integrated toluene methylation scheme. Many of the elements in FIG. 4 have the same configuration as in FIG. 1 and bear the same respective reference number and have similar operating conditions. Elements in FIG. 4 that correspond to elements in FIG. 1 but have a different configuration bear the same reference numeral as in FIG. 1 but are marked with a prime symbol (′). Further, the temperature, pressure and composition of various streams are similar to the corresponding streams in FIG. 1, unless specified otherwise. The apparatus and process in FIG. 4 are the same as in FIG. 1 with the exception of the noted following differences. In accordance with the exemplary embodiment as shown in the FIG. 4, there are two toluene columns. The first toluene column 410 produces equilibrium xylenes in conduit 412 and the second toluene column 420 produces rich paraxylene and xylenes in conduit 422. In FIG. 4, conduit 422 is directed to the paraxylene column 52, whereas conduit 51′ is directed to be coupled to conduit 60′, which is then directed to conduit 96 to be directed into the transalkylation unit 40. The benefits of this configuration include the reduction in key equipment size saving capital and operating expense.

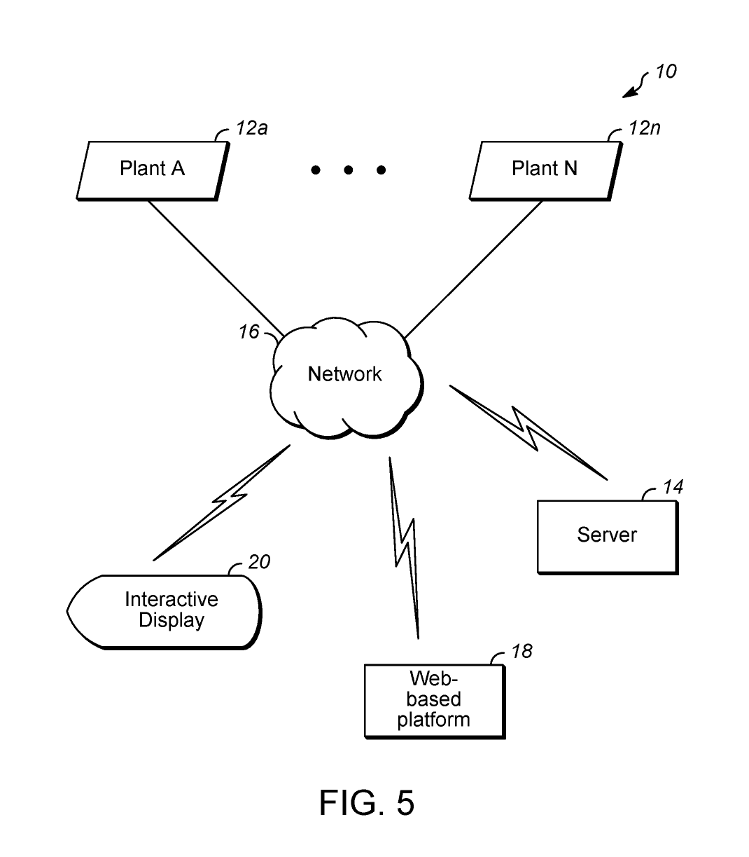

Referring now to FIG. 5, an illustrative system 10, using one or more embodiments of the present disclosure, may be provided for improving operation of one or more plants (e.g., Plant A . . . Plant N) 12a-12n, such as a chemical plant, a petrochemical plant, or refinery, or a portion thereof. The system 10 may use plant operation information obtained from one or more plants 12a-12n.

As used herein, the term “system,” “unit” or “module” may refer to, be part of, or include an Application Specific Integrated Circuit (ASIC), an electronic circuit, memory (shared, dedicated, or group) and/or a computer processor (shared, dedicated, or group) that executes one or more executable instructions (e.g., software or firmware programs) stored on the memory, a combinational logic circuit, and/or other suitable components that provide the described functionality. Thus, while this disclosure includes particular examples and arrangements of the units, the scope of the present system is not so limited, since other modifications will become apparent to the skilled practitioner.

The system 10 may reside in or be coupled to a server or computing device 14 (including, e.g., one or more database and/or video servers). The system 10 may be programmed to perform tasks and/or display relevant data for different functional units via a communication network 16, which may use a secured cloud computing infrastructure. Other suitable networks may be used, such as the internet, a wireless network (e.g., Wi-Fi), a corporate Intranet, a local area network (LAN), or a wide area network (WAN), and the like, using dial-in connections, cable modems, high-speed ISDN lines, and/or other types of communication methods. Some or all relevant information may be stored in databases for retrieval by the system 10 and/or the computing device 14 (e.g., as a data storage device and/or one or more non-transitory machine-readable data-storage media storing executable instructions).

Further, the system 10 may be partially or fully automated. In some embodiments, the system 10 may include a computer system, such as a third-party computer system, remote from the one or more plants 12a-12n and/or the plant-planning center. The system 10 may include a web-based platform 18, which may obtain, receive, and/or send information over a communication network (e.g., communication network 16, the internet, an intranet). Specifically, the system 10 may receive signals and/or parameters via the communication network. The system 10 may display (e.g., in real time, with a short delay, with a long delay) performance information related to the received signals and/or parameters on an interactive display device 20, which may be accessible to an operator or user.

Using a web-based system for implementing the method of this disclosure may provide benefits, such as improved plant performance due to an increased ability by plant operators to identify and capture opportunities, a sustained ability to bridge plant performance gaps, and/or an increased ability to leverage personnel expertise and improve training and development. The system may allow for automated daily evaluation of plant process performance, which may increase the frequency of plant performance review with less time and effort from plant operations staff.

The web-based platform 18 may allow one or more users to work with the same information, thereby creating a collaborative environment for sharing best practices or for troubleshooting. The system may provide more accurate prediction and optimization results due to fully configured models, which may include, for example, catalytic yield representations, constraints, degrees of freedom, and/or the like. Routine automated evaluation of plant planning and operation models may allow timely plant model tuning to reduce or eliminate gaps between plant models and the actual plant performance. The web-based platform 18 may allow for monitoring and/or updating multiple sites, thereby better enabling facility planners to propose realistic optimal targets.

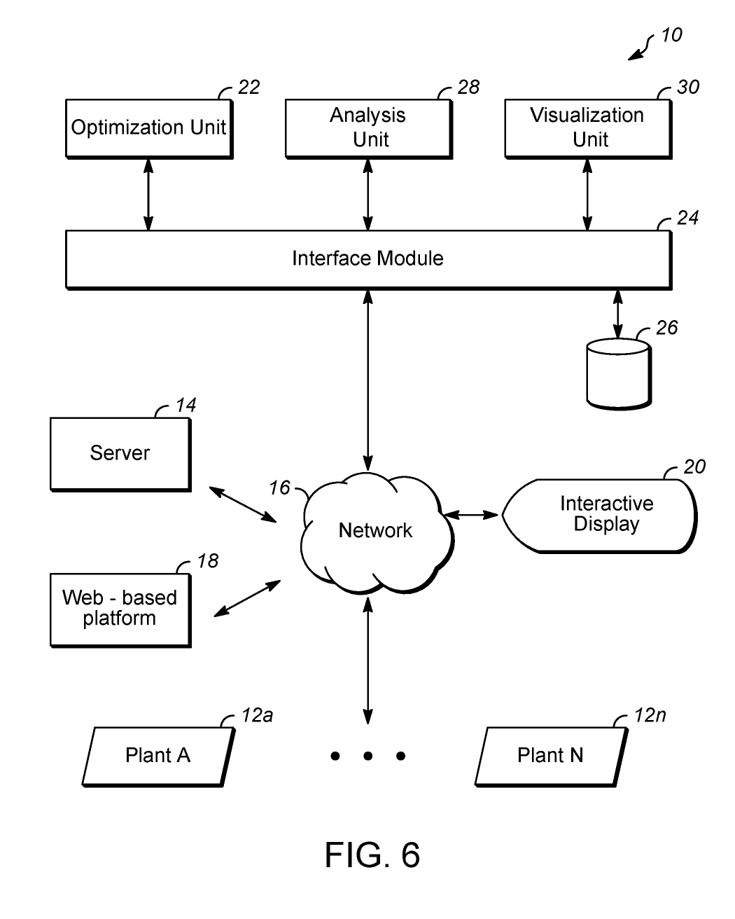

Referring now to FIG. 6, the system 10 may include an optimization unit 22 configured for optimizing at least a portion of the refining or petrochemical process of the one or more plants 12a-12n. It may be difficult for operators in the refining and petrochemical field to optimize operations at the level of an entire complex of the one or more plants 12a-12n because there may be various parameters and/or measurements that might not provide a cohesive basis for process simulation and optimization.

The system 10 may include an interface module 24 for providing an interface between the system 10, one or more internal or external databases 26, and/or the communication network 16. The interface module 24 may receive data (e.g., one or more plant parameters, sensor readings, signals, calculation results) from, for example, plant sensors via the communication network 16, and/or other related system devices, services, and/or applications. The other devices, services, and/or applications may include one or more software and/or hardware components related to the respective one or more plants 12a-12n. The interface module 24 may also receive the signals and/or parameters, which may be communicated to the respective units and modules, such as the system 10, and/or associated computing modules or units.

Process measurements from various sensor and monitoring devices may be used to monitor conditions in, around, and on process equipment (e.g., at one or more plants 12a-12n). Such sensors may include, but are not limited to, pressure sensors, differential pressure sensors, other flow sensors, temperature sensors including thermal cameras and skin thermocouples, capacitance sensors, weight sensors, gas chromatographs, moisture sensors, ultrasonic sensors, position sensors, timing sensors, vibration sensors, level sensors, liquid level (hydraulic fluid) sensors, and other sensors commonly found in the refining and petrochemical industry. Further, process laboratory measurements may be taken using gas chromatographs, liquid chromatographs, distillation measurements, octane measurements, and other laboratory measurements. System operational measurements also can be taken to correlate the system operation to the equipment measurements.

In addition, sensors may include transmitters and deviation alarms. These sensors may be programmed to set off an alarm, which may be audible and/or visual.

Other sensors may transmit signals to a processor or a hub that collects the data and sends to a processor. For example, temperature and pressure measurements may be sent to a hub (e.g., data collection platform). In one example, temperature sensors may include thermocouples, fiber optic temperature measurement, thermal cameras, and/or infrared cameras. Skin thermocouples may be applied to tubes or placed directly on a wall of an adsorption unit. Alternatively, thermal (infrared) cameras may be used to detect temperature (e.g., hot spots) in one or more aspects of the equipment, including tubes. A shielded (insulated) tube skin thermocouple assembly may be used to obtain accurate measurements. One example of a thermocouple may be a removable XTRACTO Pad. A thermocouple can be replaced without any additional welding. Clips and/or pads may be utilized for ease of replacement. Fiber Optic cable can be attached to a unit, line, or vessel to provide a complete profile of temperatures.

Furthermore, flow sensors may be used in flow paths such as the inlet to the path, outlet from the path, or within the path. If multiple tubes are utilized, the flow sensors may be placed in corresponding positions in each of the tubes. In this manner, one can determine if one of the tubes is behaving abnormally compared to other tubes. Flow may be determined by pressure-drop across a known resistance, such as by using pressure taps. Other types of flow sensors include, but are not limited to, ultrasonic, turban meter, hot wire anemometer, vane meter, Kármán™, vortex sensor, membrane sensor (membrane has a thin film temperature sensor printed on the upstream side, and one on the downstream side), tracer, radiographic imaging (e.g., identify two-phase vs. single-phase region of channels), an orifice plate in front of or integral to each tube or channel, pitot tube, thermal conductivity flow meter, anemometer, internal pressure flow profile, and/or measure cross tracer (e.g., measuring when the flow crosses one plate and when the flow crosses another plate).

Moisture level sensors may be used to monitor moisture levels at one or more locations. For example, moisture levels at an outlet may be measured. Additionally, moisture levels at an inlet of a piece of equipment may be measured. In some embodiments, a moisture level at an inlet may be known (e.g., a feed is used that has a known moisture level or moisture content).

A gas chromatograph on the feed may be used to speciate the various components to provide empirical data to be used in calculations.

Sensor data, process measurements, and/or calculations made using the sensor data or process measurements may be used to monitor and/or improve the performance of the equipment and parts making up the equipment, as discussed in further detail below. For example, sensor data may be used to detect that a desirable or an undesirable chemical reaction is taking place within a particular piece of equipment, and one or more actions may be taken to encourage or inhibit the chemical reaction. Chemical sensors may be used to detect the presence of one or more chemicals or components in the streams, such as corrosive species, oxygen, hydrogen, and/or water (moisture). Chemical sensors may utilize gas chromatographs, liquid chromatographs, distillation measurements, and/or octane measurements. In another example, equipment information, such as wear, efficiency, production, state, or other condition information, may be gathered and determined based on sensor data.

The optimization unit 22 may acquire data from a customer site or the one or more plants 12a-12n on a recurring or non-recurring basis. The optimization unit 22 may cleanse the data. Data cleansing may include analyzing the data for completeness and/or correcting the data for gross errors. Then, the data may be corrected for measurement issues (e.g., an accuracy problem for establishing a simulation steady state) and/or overall mass balance closure to generate a set of reconciled plant data. The reconciled plant data may be a duplicate of the corrected data.

The corrected data may be used as an input to a simulation process, in which the process model may be tuned to ensure that the simulation process matches the reconciled plant data. An output of the reconciled plant data may be input into a tuned flowsheet, and then may be generated as a predicted data. One or more flowsheets may be a collection of virtual process model objects as a unit of process design. A delta value, which is a difference between the reconciled data and the predicted data, may be validated to ensure that a viable optimization case is established for a simulation process run.

Next, a tuned simulation engine may be used as a basis for the optimization case, which may be run with a set of the reconciled data as an input. The output from this step may be a new set of data (e.g., optimized data). A difference between the reconciled data and the optimized data may provide an indication as to how the plant operations may be changed to improve performance. In some embodiments, the optimization unit 22 may provide a configurable method for minimizing objective functions, thereby maximizing production of the one or more plants 12a-12n.

In some embodiments, the optimization unit 22 may define an objective function as a calculation of one or more or all operational inputs for a particular process, including materials consumed, products produced, and/or utilities utilized, subject to various constraints. For example, a maximum hydraulic limit may be determined by a flooding limit subject to a fractionating column capacity. In another example, a maximum temperature in a furnace may be determined based on a temperature of a furnace tube or heater. Other suitable objective functions may suit different applications.

The system 10 may include an analysis unit 28 configured for determining an operating status of the refinery or petrochemical plant to ensure robust operation of the one or more plants 12a-12n. The analysis unit 28 may determine the operating status based on one or more of a kinetic model, a parametric model, an analytical tool, related knowledge, and/or a best practice standard.

In some embodiments, the analysis unit 28 may receive historical or current performance data from the one or more plants 12a-12n to proactively predict future actions to be performed. To predict various limits of a particular process and stay within the acceptable range of limits, the analysis unit 28 may determine target operational parameters of a final product based on actual current and/or historical operational parameters, e.g., from a steam flow, a heater, a temperature set point, a pressure signal, and/or the like.

For example, in using the kinetic model or other detailed calculations, the analysis unit 28 may establish boundaries and/or thresholds of operating parameters based on existing limits and/or operating conditions. Illustrative existing limits may include mechanical pressures, temperature limits, hydraulic pressure limits, and/or operating lives of various components. Other suitable limits and conditions may suit different applications.

In using the knowledge and best practice standard, such as specific know-hows, the analysis unit 28 may establish one or more relationships between operational parameters related to the specific process. For example, the boundaries on a naphtha reforming reactor inlet temperature may be dependent on a regenerator capacity and/or hydrogen-to-hydrocarbon ratio, which itself may be dependent on a recycle compressor capacity.

The system 10 may include a visualization unit 30 configured for displaying plant performance variables using the display device 20. The visualization unit 30 may display a current state of the one or more plants 12a-12n using a dashboard, grouping related data into one or more display sets based on a source of the data for meaningfully illustrating relationships of the displayed data.

In some embodiments, the system 10 may interface with the communication network 16, and/or perform the performance analysis of the given one or more plants 12a-12n. The system 10 may manage one or more interactions between the operators and the present system by way of a human-machine interface (HMI), such as a keyboard, a touch sensitive pad or screen, a mouse, a trackball, a voice recognition system, and/or the like.

In some embodiments, the display device 20 (e.g., textual and graphical) may be configured for receiving an input signal from the operators and/or the system 10. In some embodiments, the system 10 may receive graphical and/or textual input from an input device via an interface (e.g., the HMI). The HMI may be part of the display device 20. In some embodiments, the system 10 may receive one or more input signals and/or parameters, and transfer the received input signals and/or parameters to the display device 20 via a dedicated communication system, e.g., using a cloud-computing infrastructure.

Corrective action may be taken based on determining equipment information (e.g., based on sensor data). For example, if the equipment is showing signs of wear or failure, corrective actions may be taken, such as taking an inventory of parts to ensure replacement parts are available, ordering replacement parts, and/or calling in repair personnel to the site. Certain parts of equipment may be replaced immediately. Other parts may be safe to continue to use, but a monitoring schedule may be adjusted. Alternatively or additionally, one or more inputs or controls relating to a process may be adjusted as part of the corrective action. These and other details about the equipment, sensors, processing of sensor data, and actions taken based on sensor data are described in further detail below.

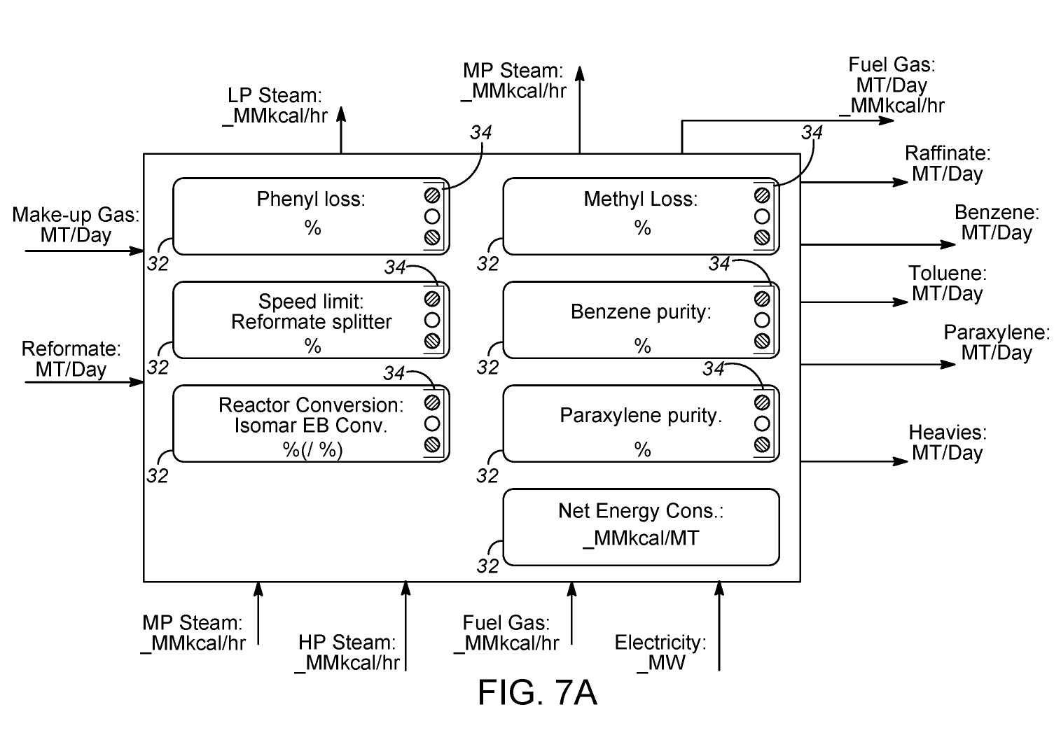

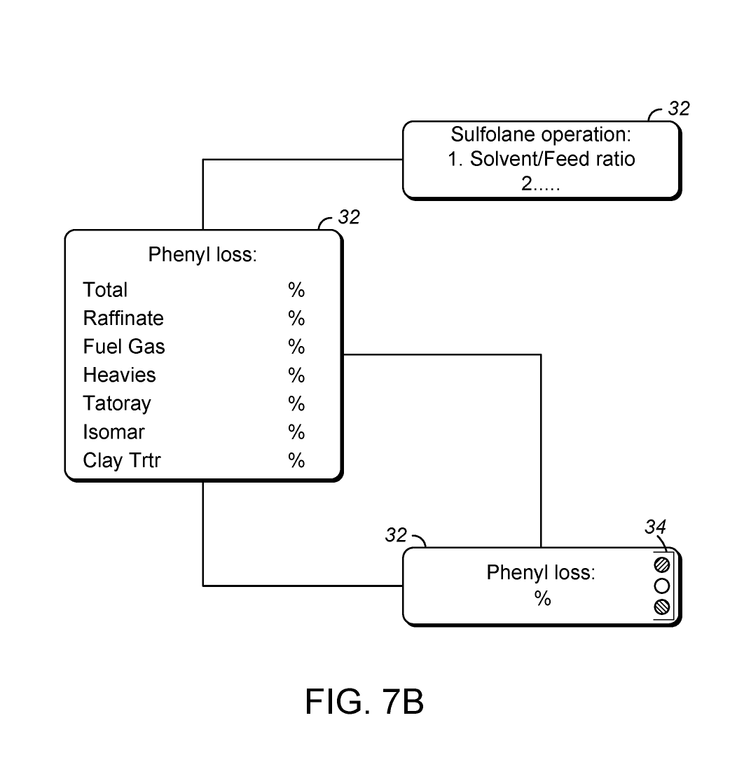

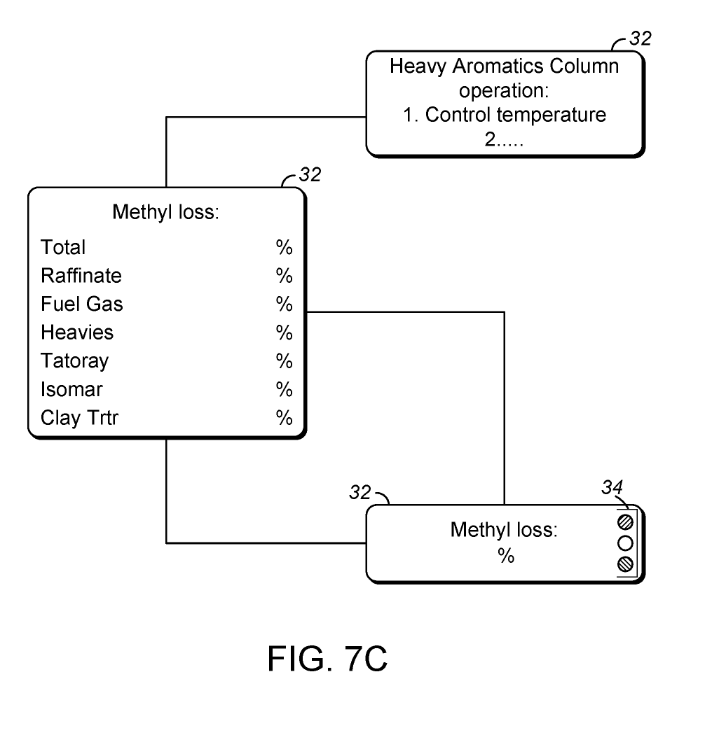

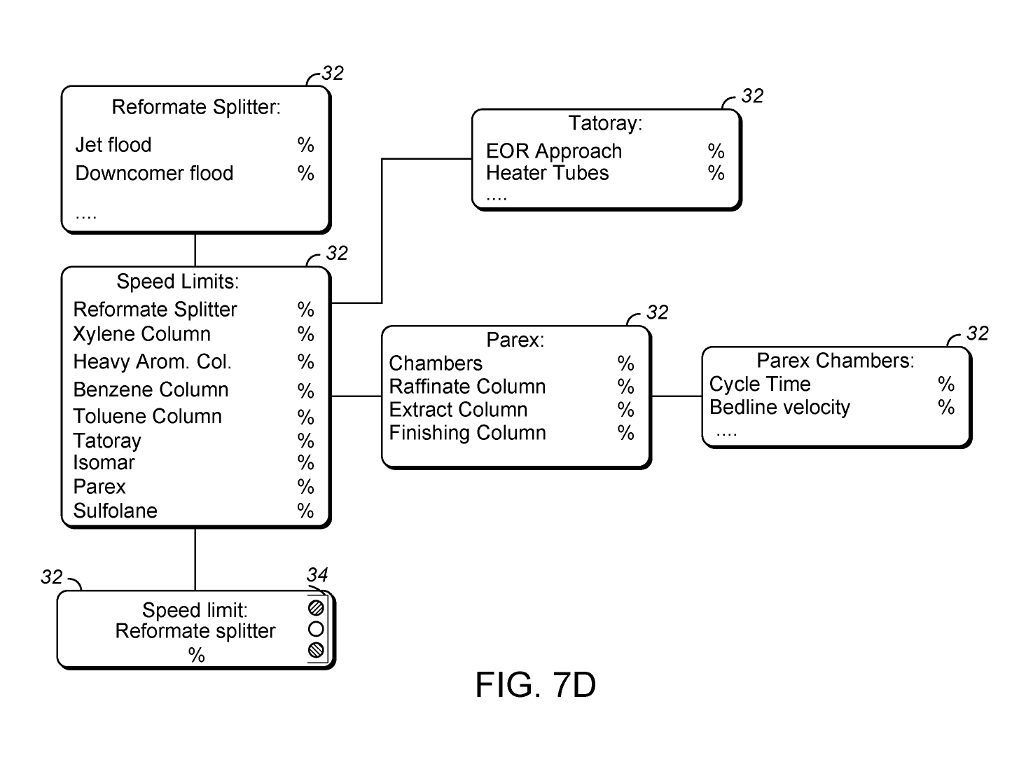

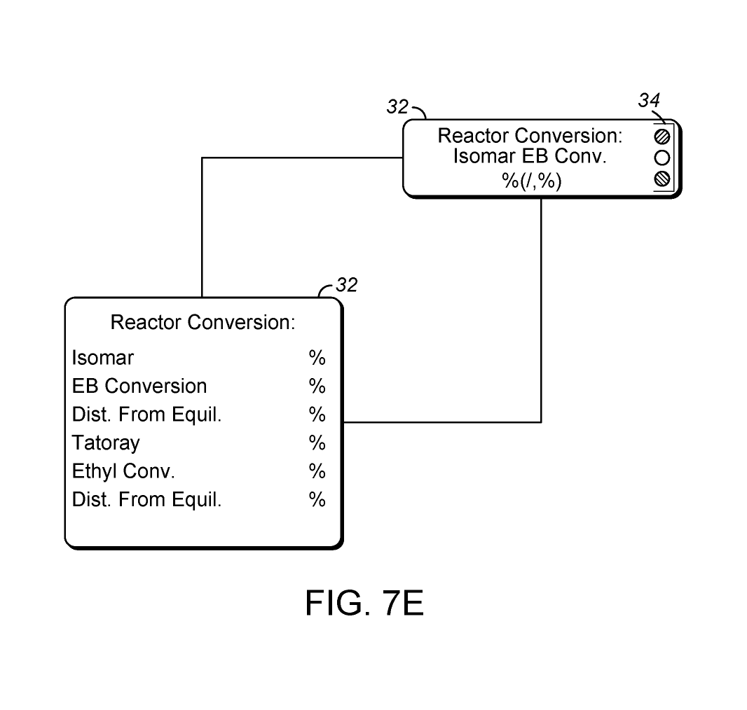

Referring now to FIGS. 7A-7E, an illustrative dashboard is depicted. The illustrative dashboard, which may use hue and color techniques, may interpolate color indications and/or other signals for the plant parameters (or plant data). The visualization unit 30 may create an interactive and/or visually engaging display. In some embodiments, the dashboard may highlight or emphasize one or more important parameters. In some embodiments, the important parameters may be associated with additional information (e.g., additional insight) about a meaning, implication, or result of the important parameters. The additional information may be presented using the hue and color techniques. One or more other suitable visualization techniques having visual indicators may be used to readily discriminate the quality of displayed data on the display device 20. Specifically, the visualization unit 30 may provide a hierarchical structure of detailed explanation on the parameters shown on the display device 20, such that the user interface may be configured to selectively expand or drill down into a particular level of the parameters.

For example, to achieve the drill-down navigation, the interface may receive a selection (e.g., a click, tap, drag, highlight) of a display item 32 in the initial screen. The selection may cause the interface to start and/or open a new display window with more detailed information about the parameter calculation. The interface may receive a further selection on the corresponding display item 32, and may generate more information such that the interface may provide desired specific information as needed.

The visualization unit 30 may display one or more parameters related to an aromatics complex. FIG. 7A depicts an illustrative display window illustrating high-level process effectiveness calculations and energy efficiency parameters of the plant 12 along with important operating limits. The operating limits may be adaptive, depending on which parameters are the closest to their limits. More specifically, the operating limits may be displayed based on at least one of the operational parameters, such as yields and losses, an energy efficiency, operational thresholds or limits, a process efficiency or purity, and/or the like. Other suitable parameters may be used to suit the application.

In one illustrative example, depicted in FIG. 7A, the yields and losses may include phenyl and methyl losses, the energy efficiency may include net energy consumption, the operational limits may include speed limits or flow rates, and the process efficiency may include reactor conversion. Utility inputs—such as steam, gas, and electricity—may be displayed on the display device 20. Utility outputs—such as operational parameters and values—may be displayed on the display device 20. The displayed parameters may include time-based information. In some embodiments, the time-based information may be displayed in the form of miniature trends, which may be adjacent to associated parameter values.

Similarly, FIGS. 7B-7E depict illustrative sublevels of the display items 32, featuring more detailed descriptions of the corresponding higher level display items. A sublevel may be displayed in response to a selection of a display item 32. For example, if the interface receives input selecting phenyl loss 32, the interface may change (e.g., show a pop-up window, a new screen, a different view) to show additional details about the phenyl loss 32.

FIG. 7B depicts an illustrative sublevel interface that includes detailed information about the phenyl loss 32 item of FIG. 7A. The detailed information may include one or more percentages corresponding to the phenyl loss, such as a total percentage, a raffinate percentage, a fuel gas percentage, a heavies percentage, a tatoray percentage, an isomar percentage, and/or a clay trtr percentage.

The illustrative sublevel interface may, in some embodiments, include additional information. In some embodiments, the additional information may be included on a same interface as the detailed information. In some embodiments, the additional information may be accessible by a drill-down interface. For example, the interface may receive a further selection of an interface object on the sublevel interface, and in response, the interface may change to show the additional information about the phenyl loss 32. The additional information may include, for example, information about sulfolane operation, including, e.g., solvent/feed ratio.

FIG. 7C depicts an illustrative sublevel interface that includes detailed information about the methyl loss 32 item of FIG. 7A. The detailed information may include one or more percentages corresponding to the methyl loss, such as a total percentage, a raffinate percentage, a fuel gas percentage, a heavies percentage, a tatoray percentage, an isomar percentage, and/or a clay trtr percentage.

The illustrative sublevel interface may, in some embodiments, include additional information. In some embodiments, the additional information may be included on a same interface as the detailed information. In some embodiments, the additional information may be accessible by a drill-down interface. For example, the interface may receive a further selection of an interface object on the sublevel interface, and in response, the interface may change to show the additional information about the methyl loss 32. The additional information may include information about heavy aromatics column operation, including, e.g., control temperature.

FIG. 7D depicts an illustrative sublevel interface that includes detailed information about the speed limit reformate splitter 32 item of FIG. 7A. The detailed information may include one or more percentages corresponding to the speed limit reformate splitter, such as a reformate splitter percentage, a xylene column percentage, a heavy arom. column percentage, a benzene column percentage, a toluene column percentage, a tatoray percentage, an isomar percentage, a parex percentage, and/or a sulfolane percentage.

The illustrative sublevel interface may, in some embodiments, include additional information. In some embodiments, the additional information may be included on a same interface as the detailed information. In some embodiments, the additional information may be accessible by a drill-down interface. For example, the interface may receive a further selection of an interface object on the sublevel interface, and in response, the interface may change to show the additional information about the speed limits 32. The additional information may include information about reformate splitter, including, e.g., jet flood percentage and/or downcomer flood percentage. The additional information may include information about tatoray, including, e.g., EOR approach percentage and/or heater tubes percentage. The additional information may include information about, e.g., parex, including, e.g., chambers percentage, raffinate column percentage, extract column percentage, and/or finishing column percentage.

The interface may provide for a still further selection of an additional information interface object on the interface, and in response, the interface may change to show still further information. For example, the additional information about the parex may be selected to show still further information about the parex chambers, including, e.g., cycle time percentage and/or bedline velocity percentage.

Thus, one or more of the interface objects may be selected in a drill-down manner to request additional information about one or more of the items displayed in the interface objects. The additional information may in turn be selected to provide still further information, which may itself be selected to provide still further information, and so on.

FIG. 7E depicts an illustrative sublevel interface that includes detailed information about the reactor conversion 32 item of FIG. 7A. The detailed information may include one or more percentages corresponding to the reactor conversion, such as an isomar percentage, an EB conversion percentage, a distance from equilibrium percentage, a tatoray percentage, an ethyl conversion percentage, and/or a distance from equilibrium percentage.

The illustrative sublevel interface may, in some embodiments, include additional information. In some embodiments, the additional information may be included on a same interface as the detailed information. In some embodiments, the additional information may be accessible by a drill-down interface. For example, the interface may receive a further selection of an interface object on the sublevel interface, and in response, the interface may change to show the additional information about the reactor conversion 32. The additional information may include information about reactor conversion, including, e.g., isomar EB conversion.

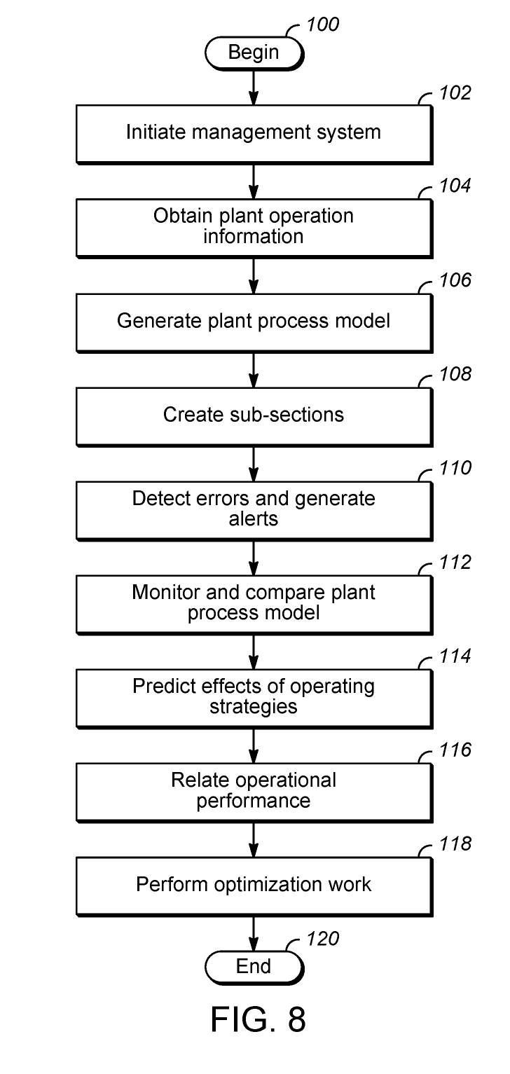

Referring now to FIG. 8, a simplified flow diagram is depicted for an illustrative method of improving operation of a plant, such as the one or more plants 12a-12n of FIGS. 5 and 6, according to one or more embodiments of this disclosure. Although the following steps are primarily described with respect to the embodiments of FIGS. 5 and 6, the steps within the method may be modified and/or executed in a different order or sequence without altering the principles of the present disclosure.

The method begins at step 100. In step 102, the system 10 may be initiated by a computer system that is local to or remote from the one or more plants 12a-12n. The method may be automatically performed by the computer system; but the disclosure is not so limited. One or more steps may include manual operations or data inputs from the sensors and other related systems.

In step 104, the system 10 may obtain plant operation information or plant data from the one or more plants 12a-12n over the communication network 16. The plant operation information or plant data may include plant process condition data or plant process data, plant lab data, and/or information about plant constraints. The plant data may include at least one of: the plant lab data, the plant process condition data, and/or the plant constraint. As used herein, “plant lab data” refers to the results of periodic laboratory analyses of fluids taken from an operating process plant. As used herein, “plant process data” refers to data measured by sensors in the process plant.

In step 106, a plant process model may be generated using the plant operation information. The plant process model may predict plant performance that may be expected based on the plant operation information. The plant process model results may be used to monitor the health of the one or more plants 12a-12n, and/or to determine whether any upset or poor measurement occurred. The plant process model may be generated by an iterative process that models based on various plant constraints to determine the plant process model.

In step 108, a process simulation unit may model the operation of the one or more plants 12a-12n. Because the simulation for the entire unit might be quite large and complex to solve in a reasonable amount of time, the one or more plants 12a-12n may be divided into smaller virtual sub-sections. In some embodiments, the smaller virtual sub-sections may be determined according to related unit operations. An illustrative process simulation unit 10, such as a UniSim® Design Suite, is disclosed in U.S. Patent Publication No. 2010/0262900, which is incorporated by reference in its entirety. In some embodiments, the process simulation unit 10 may be installed in the optimization unit 22.

For example, in some embodiments, a fractionation column and its related equipment such as its condenser, receiver, reboiler, feed exchangers, and pumps may make up a sub-section. Some or all available plant data from the unit, including temperatures, pressures, flows, and/or laboratory data, may be included in the simulation as Distributed Control System (DCS) variables. Multiple sets of the plant data may be compared against the process model. Model fitting parameter and/or measurement offsets may be calculated that generate the smallest errors.

In step 110, fit parameters or offsets that change by more than a predetermined threshold, and/or measurements that have more than a predetermined range of error, may trigger further action. Large changes in offsets or fit parameters may indicate the model tuning may be inadequate. Overall data quality for the set of data may be flagged as questionable. Individual measurements with large errors may be eliminated from the fitting algorithm. An alert message or warning signal may be raised to have the measurement inspected and rectified.

In step 112, the system 10 may monitor and/or compare the plant process model with actual plant performance to ensure the accuracy of the plant process model. In some embodiments, effective process models accurately reflect the actual operating capabilities of the commercial processes. This may be achieved by calibrating models to reconciled data. Key operating variables, such as cut points and tray efficiencies, may be adjusted to minimize differences between measured and predicted performance. In some embodiments, the plant process model may be updated based on a predetermined difference between the plant process model and actual plant performance. The updated plant process model may be used during the next cycle of the method. The updated plant process model may be used to optimize the plant processes.

In step 114, the plant process model may be used to accurately predict the effects of varying feedstocks and/or operating strategies. Consequently, regular updating or tuning of the plant process model according to the method of this disclosure using reconciled data may enable the refiner to assess changes in process capability. A calibrated, rigorous model of this type may enable the system 10 to identify process performance issues, so that they may be addressed before they have a serious impact on plant operations.

For example, calculations such as yields, product properties, and/or coke production rate may be key indicators of process problems when examined as trends over time. Regular observation of such trends may indicate abnormal declines in performance or mis-operations. For example, if a rapid decline in C₅₊ hydrocarbon yields in a naphtha reforming unit is observed, this may point to an increasing rate of coke production, which then may be traced back to an incorrect water-chloride balance in the reactor circuit or incorrect platforming feed pre-treatment. In some embodiments, the plant process model may support improvement studies that consider both short-term operational changes and long-term revamp modifications to generate improved performance on the unit.

In step 116, an output interface may be designed to directly or indirectly relate operational performance to the primary operating variables of the plant (e.g., flow of steam to a heat exchanger or setpoint on a column composition controller). This may be accomplished by relating the operational performance levels to the plant operation through a cascade of more detailed screens. Each detailed screen may be configured to display variables that are causing the departure from the target performance level.

In some embodiments, a top level screen may display key process effectiveness parameters (e.g., yield of desired product as a ratio of feed consumed), process efficiency (e.g., energy consumption per unit product), and/or process capacity (e.g., current operating capacity as a ratio of design or available capacity). One or more parameters may be displayed with an icon 34 that corresponds to the parameter's condition (e.g., a multicolor, multi symbol, multi shade, or other multi variable indicator, where each of multiple indicators correspond to different conditions of the parameter). For example, an icon could include a red-yellow-green indicator (e.g., similar to a traffic light) corresponding to whether the parameter is out of range (red), nearly out of range (yellow), or within expected range (green)). The interface may receive a selection of a parameter, and in response may provide a particular display with the next hierarchical level of parameters that are related to it. This may continue until the interface reaches the level of the measured value at the plant.

As an example, the one or more plants 12a-12n may convert and separate an aromatic-hydrocarbon rich stream into high-valued product streams of benzene and paraxylene. A corresponding top-level display may include overall process effectiveness parameters, such as desired product production per unit feed and/or conversion or retention of functional molecular groups (e.g., phenyl groups or methyl groups). In this example, a typical overall plant methyl loss may be 2%. If the actual methyl loss is greater than a threshold (e.g., 2.2%), the parameter may be flagged (e.g., with a red light).

In response to receiving a selection of the methyl loss parameter, the interface may provide a display of some or all unit operations in the plant 12 that affect methyl loss. For example, methyl loss may be affected by fractionation unit operations (e.g., improper reflux-to-feed ratio and/or incorrect target operating temperature) and/or conversion unit operations (e.g., non-selective reactions). The interface may indicate which unit operations in the plant 12 that affect methyl loss, if any, are out of range. According to this example, the transalkylation reactor may be the largest contributor to methyl loss, and may be what is causing the overall methyl loss to be high (e.g., normally 1.08% and considered high if more than 1.25%).

The interface may receive a selection of the transalkylation reactor, and in response the interface may provide a display of a level of further detail, which may indicate the health of the reactor that is converting it. This health may include one or more operating conditions, such as hydrogen-to-hydrocarbon ratio (e.g., typically 3.0), reactor pressure (e.g., typically ˜2.76 MPa (gauge) or ˜400 psi), and/or reactor inlet temperature (e.g., typically 375° C. or 707° F.). Ultimately, the final display screen of the interface may depict which operating variable (e.g., reactor inlet temperature) needs to be adjusted to improve the overall plant operation. The display may be based on data from pilot plant testing and/or operating experience, which may be used to determine the operating envelopes. For example, the reactor inlet temperature operating range for a typical transalkylation reactor may be in the range of between 360° C. (or 680° F.) and 400° C. (or 752° F.).

A benefit of the method may be long-term sustainability. Often, projects to improve plant performance may achieve reasonable benefits for a modest duration, but these improvements decay over time. This decay may be the result of inadequate time and/or expertise of available in-house technical personnel. Web-based optimization may bridge existing performance gaps and better leverage data to provide operational improvements that may be sustained in the long term.

In some embodiments, locally installed process models may be used to address the optimization needs of a plant or refinery. Alternatively, in some embodiments, a web-enabled platform may remotely host the process models, and the remotely hosted process models may be remotely maintained and/or tuned.

In some embodiments, process models may be tuned, for example, based on catalyst deactivation, temporary equipment limitations, and the like. In some embodiments process models may be configured to take into account plant flow scheme and/or equipment modifications.

Returning to FIG. 8, in step 118, an optimization work process may be performed. The optimization may include allocating resources to process units that either have the highest feed processing opportunity or the most need for maintenance and upgrade.

Further advantage may be achieved by using a common infrastructure that clearly establishes links between the plant process and performance. For example, all process, analytical, and operational data may be used to provide one or more reports, which may be linked through process models. The method ends at step 120.

Without further elaboration, one skilled in the art may use the disclosure to its fullest extent and easily ascertain the essential characteristics of this disclosure, without departing from the spirit and scope thereof, to make various changes and modifications of the disclosure and to adapt it to various usages and conditions. Any specific embodiments are, therefore, to be construed as merely illustrative, and not limiting the remainder of the disclosure in any way whatsoever. The disclosure covers various modifications and equivalent arrangements included within the scope of the appended claims.

In the foregoing, all temperatures are set forth in degrees Celsius and all parts and percentages are by weight, unless otherwise indicated.

While particular embodiments of a system have been described herein, it will be appreciated by those skilled in the art that changes and modifications may be made thereto without departing from the disclosure and as set forth in the following claims.

What is claimed is:

1. A system for improving operation of a petrochemical plant, the system comprising:
a column;
a reactor;
one or more heaters;
a compressor;
one or more sensors configured to collect plant data related to operation of the petrochemical plant, the plant data associated with at least one of the column, the reactor, the one or more heaters, or the compressor;
a collection platform comprising:
one or more processors; and
memory storing executable instructions that, when executed by the one or more processors of the collection platform, cause the collection platform to:
receive the plant data from the one or more sensors;
an interface platform comprising:
one or more processors; and
memory storing executable instructions that, when executed by the one or more processors of the interface platform, cause the interface platform to:
provide an interface between the collection platform, a database configured to store the plant data, and a communication network; and
receive, via the communication network and from the collection platform, the plant data related to operation of the petrochemical plant; and
an optimization platform comprising:
one or more processors; and
memory storing executable instructions that, when executed by the one or more processors of the optimization platform, cause the interface platform to:
analyze for completeness the plant data related to operation of the petrochemical plant;
correct the plant data for a measurement issue and an overall mass balance closure;
generate a set of reconciled plant data based on the corrected plant data;
determine, based on the reconciled plant data, a recommendation for an optimization to a process of the petrochemical plant; and
transmit, to a remote device, the recommendation for the optimization to the process of the petrochemical plant based on the reconciled plant data.

2. The system of claim 1, wherein the memory of the optimization platform stores executable instructions that, when executed by the one or more processors of the optimization platform, cause the optimization platform to:
use the corrected data as an input to a simulation process in which a process model is tuned to ensure that the simulation process matches the reconciled plant data; and
define an objective function as a calculation of total operational inputs during the operation of the petrochemical plant.

3. The system of claim 1, wherein the memory of the optimization platform stores executable instructions that, when executed by the one or more processors of the optimization platform, cause the optimization platform to:
provide an output of the reconciled plant data to a tuned flowsheet, the tuned flowsheet comprising a collection of virtual process model objects as a unit of process design; and
generate predicted data based on the reconciled plant data.

4. The system of claim 3, wherein the memory of the optimization platform stores executable instructions that, when executed by the one or more processors of the optimization platform, cause the optimization platform to:
validate a delta value representing a difference between the reconciled data and the predicted data;
ensure, based on the delta value, that a viable optimization case is established for a simulation process;
run the viable optimization case in the simulation process on a tuned simulation engine with the reconciled data as an input to the simulation process, the tuned simulation engine outputting optimized data; and
determine, based on a difference between the reconciled data and the optimized data, one or more plant variables that are capable of being changed to result in an improved performance of the petrochemical plant.

5. The system of claim 1, comprising:
an analysis platform comprising:
one or more processors; and
memory storing executable instructions that, when executed by the one or more processors of the analysis platform, cause the analysis platform to:
determine an operating status of the petrochemical plant based on at least one of: a kinetic model, a parametric model, an analytical tool, a related knowledge standard, or a best practice standard.

6. The system of claim 5, wherein the memory of the analysis platform stores executable instructions that, when executed by the one or more processors of the analysis platform, cause the analysis platform to:
determine a target operational parameter of a final product of the petrochemical plant based on at least one of: an actual current parameter of the petrochemical plant or a historical operational parameter of the petrochemical plant.

7. The system of claim 5, wherein the memory of the analysis platform stores executable instructions that, when executed by the one or more processors of the analysis platform, cause the analysis platform to:
determine a boundary or threshold of an operating parameter of the petrochemical plant based on at least one of: an existing limit of the petrochemical plant or an operation condition of the petrochemical plant; and
establish a relationship between at least two operational parameters related to a specific process of the petrochemical plant.

8. The system of claim 1, comprising:
a visualization platform comprising:
one or more processors; and
memory storing executable instructions that, when executed by the one or more processors of the visualization platform, cause the visualization platform to:
generate a display of plant performance variables; and
generate a dashboard comprising:
a display of a current state of the petrochemical plant, and
related data grouped into one or more display sets based on a source of the plant data and to illustrate a relationship of the related data.

9. A system for improving operation of a petrochemical plant, the system comprising:
a column;
a reactor;
one or more heaters;
a compressor;
one or more sensors configured to collect plant data related to operation of the petrochemical plant, the plant data associated with at least one of the column, the reactor, the one or more heaters, or the compressor;
an interface platform comprising:
one or more processors; and
memory storing executable instructions that, when executed by the one or more processors of the interface platform, cause the interface platform to:
receive and send, via a communication network, the plant data related to the operation of the petrochemical plant;
a display device configured to:
interactively display, via a display interface, the plant data related to the operation of the petrochemical plant; and
receive, via the display interface, a graphical or textual input signal; and
a visualization platform comprising:
one or more processors; and
memory storing executable instructions that, when executed by the one or more processors of the visualization platform, cause the visualization platform to:
generate the display interface; and
generate a display of the plant data, the display comprising a visual indicator based on a hue and color technique that corresponds to a quality of the displayed plant data.

10. The system of claim 9, wherein the memory of the visualization platform stores executable instructions that, when executed by the one or more processors of the visualization platform, cause the visualization platform to:
provide a hierarchical structure of detailed explanation of the displayed plant data, wherein the hierarchical structure is configured to be selectively expanded or drilled down into a particular level of the plant data; and
provide a drill-down navigation in response to receiving a selection of a display item of the display interface, the drill-down navigation configured to open a new display window comprising more detailed information about the plant data than an initial screen of the display interface.

11. The system of claim 9, wherein the memory of the visualization platform stores executable instructions that, when executed by the one or more processors of the visualization platform, cause the visualization platform to:
include, with the display of the plant data related to the operation of the petrochemical plant, plant data related to an aromatics complex.

12. The system of claim 9, wherein the memory of the visualization platform stores executable instructions that, when executed by the one or more processors of the visualization platform, cause the visualization platform to:
generate a display of a high-level process effectiveness calculation of the petrochemical plant;
generate a display of an energy efficiency parameter of the petrochemical plant with a corresponding operating limit;
generate a display of a utility input related to the operation of the petrochemical plant; and
generate a display of a utility output related to the operation of the petrochemical plant.

13. The system of claim 9, wherein the memory of the visualization platform stores executable instructions that, when executed by the one or more processors of the visualization platform, cause the visualization platform to:
include, with the display of the plant data, time-based information in a form of a trend disposed adjacent to an associated parameter value; and
generate, as at least part of the visual indicator, an icon having a red-yellow-green configuration corresponding to whether the plant data is out of range, nearly out of range, or within an expected range.

14. A method for improving operation of a petrochemical plant comprising a column, a reactor, one or more heaters, and a compressor, the method comprising:
receiving, from one or more sensors, plant data related to operation of the petrochemical plant, the plant data associated with at least one of the column, the reactor, the one or more heaters, or the compressor;
generating an interactive display of the plant data, the interacting display comprising a visual indicator based on a hue and color technique, the visual indicator discriminating a quality of the displayed plant data; and
generating a plant process model that uses the plant data to predict plant performance of the petrochemical plant, the plant process model being generated by an iterative process that, at each iteration, models at least one plant constraint of the petrochemical plant.

15. The method of claim 14, comprising:
dividing the operation of the petrochemical plant into a plurality of virtual sub-sections, each sub-section corresponding to a unit operation.

16. The method of claim 14, comprising:
comparing the plant data with the plant process model and a fit parameter for calculating a measurement offset;
determining a change in the fit parameter by more than a predetermined threshold; and
generating an alert based on the change in the fit parameter by more than the predetermined threshold.

17. The method of claim 14, comprising:
determining a change in a measurement offset that has more than a predetermined range of error; and
generating an alert based on the change in the measurement offset that has more than the predetermined range of error.

18. The method of claim 14, comprising:
calibrating the plant process model based on a reconciled data by adjusting the plant data to minimize a difference between measured performance of the petrochemical plant and predicted performance of the petrochemical plant; and
predicting an effect of the plant process model by regularly updating or tuning the plant process model using the reconciled data.

19. The method of claim 14, comprising:
updating the plant process model based on a predetermined difference between the plant process model and actual plant performance of the petrochemical plant; and
using the updated plant process model during a next cycle of the operation of the petrochemical plant.

20. The method of claim 14, comprising:
determining a fault of the operation of the petrochemical plant based on a trend of a key indicator of the petrochemical plant during a predetermined time period; and
performing an optimization process by providing a common set of information linking the plant process model and operational performance of the petrochemical plant.
